(19) United States
(12) Patent Application Publication
(10) Pub. No.: US 2026/0318797 A1
(43) Pub. Date: Oct. 15, 2026

(54) Device and Method for Non-destructive Testing of Mechanical Properties and Residual Stress of Pressure Vessels

(71) Applicant: China University of Petroleum (East China), Qingdao (CN)

(72) Inventors: Bin YANG, Qingdao (CN); Wenchun JIANG, Qingdao (CN); Xuecong HOU, Qingdao (CN); Xinjie ZHANG, Qingdao (CN); Xiaoming SHAO, Qingdao (CN); Yansong WANG, Qingdao (CN); Zeyu LI, Qingdao (CN)

(73) Assignee: China University of Petroleum (East China), Qingdao (CN)

(21) Appl. No.: 19/541,353

(22) Filed: Feb. 16, 2026

(30) Foreign Application Priority Data
Apr. 11, 2025 (CN) 202510451570.0

(51) Int. Cl. G01N 3/08

(52) U.S. Cl. CPC G01N 3/08; G01N 2203/0266

(57) ABSTRACT

The present invention discloses a device and method for non-destructive testing of mechanical properties and residual stress of pressure vessels. The device comprises a pressure vessel simulator, an indenter, and a moving mechanism; the indenter adjusts its testing position via the moving mechanism and performs non-destructive testing on the pressure vessel simulator; the pressure vessel simulator has an intermediate circumferential weld formed by butt welding of a first and second cylindrical section, and a first and second longitudinal weld formed by rolling and welding the first and second cylindrical sections together; the device further comprises a water inlet; the moving mechanism comprises two parallel horizontal guide rails and two parallel arc-shaped guide rails; the arc-shaped guide rails are vertically positioned above the horizontal guide rails and surround the pressure vessel simulator. The present invention provides a device and method for simulating the service environment of pressure vessels in a laboratory and performing non-destructive testing on their mechanical properties and residual stress, providing theoretical guidance for pressure vessel manufacturing in engineering projects.

### CROSS-REFERENCE

This application claims the benefit of priority from China Patent Application No. CN 202510451570.0 filed on Apr. 11, 2025, the contents of which are hereby incorporated by reference in their entirety.

### TECHNICAL FIELD

The present invention relates to the field of residual stress testing technology, specifically to a device and method for non-destructive testing of the mechanical properties and residual stress of pressure vessels.

### BACKGROUND ART

Pressure vessels are sealed containers capable of withstanding pressure and are widely used in petrochemical and other fields. Failure of pressure vessels can lead to serious safety accidents and environmental pollution; therefore, safety and reliability thereof are crucial to ensuring the safety of life and property of production and operating personnel. To ensure the safety and reliability of pressure vessels, scientific safety assessments are required during the pressure vessel design phase. Currently, simulation methods are commonly used to assess reliability, such as simulating the residual stress distribution after welding and heat treatment, or the mechanical properties of pressure vessels during pressurized use. However, simulation results still differ from on-site test results.

Based on this, an apparatus and method are proposed that can simulate the service environment of pressure vessels in a laboratory and perform non-destructive testing on their mechanical properties and residual stress, providing theoretical guidance for pressure vessel manufacturing in engineering fields.

### SUMMARY OF THE INVENTION

To address the aforementioned technical problems, the present invention proposes a device and method for non-destructive testing of mechanical properties and residual stress of pressure vessels. This device can simulate the service environment of pressure vessels in a laboratory setting and perform non-destructive testing on mechanical properties and residual stress thereof, accurately assessing safety and reliability of pressure vessels and providing theoretical guidance for pressure vessel manufacturing in engineering projects.

Specifically, the present invention adopts the following technical solution:

A device for non-destructive testing of mechanical properties and residual stress of pressure vessels, comprising a pressure vessel simulator, an indenter, and a moving mechanism; the pressure vessel simulator comprises a cylinder formed by butt welding a first cylinder section and a second cylinder section, and end caps disposed at both ends of the cylinder; both the first and second cylinder sections are formed by rolling and welding; one end cap of the pressure vessel simulator is provided with a water inlet, and another end cap is provided with a pressure gauge mounting port and a safety valve mounting port;
the moving mechanism comprises two parallel horizontal guide rails and two parallel arc-shaped guide rails; the curved guide rails are vertically positioned above the horizontal guide rails; bottom ends of each of the curved guide rails are slidably connected to the two horizontal guide rails via a first sliding assembly; a second sliding assembly is located on opposite sides of the two curved guide rails; and a left end and a right end of the indenter are slidably connected to the two curved guide rails via the second sliding assembly;
the pressure vessel simulation component is fixed to a fixed base plate using a support assembly located at a bottom portion of the cylinder near the end caps; the two curved guide rails surround the pressure vessel simulation component; the indenter adjusts a detection position thereof via the moving mechanism and performs non-destructive testing on the pressure vessel simulation component.

Furthermore, the first cylinder section and the second cylinder section of the pressure vessel simulation component are made of the same material or different materials.

The pressure vessel simulation component has an intermediate circumferential weld seam formed by butt welding of the first cylinder section and the second cylinder section, and a first longitudinal weld seam and a second longitudinal weld seam formed by welding the first cylinder section and the second cylinder section after rolling to be the cylinder.

Furthermore, the two horizontal guide rails are fixedly positioned above the fixed base plate.

Further, the first sliding assembly comprises a slider or a pulley system, and the second sliding assembly comprises a pulley system.

Furthermore, the support assembly comprises a base support plate, a vertical support plate, and a top support plate; the base support plate is fixedly disposed above the fixed base plate; both ends of the vertical support plate are respectively fixed to the base support plate and the top support plate; the top support plate is arc-shaped and matches an outer diameter of the pressure vessel simulation component and the pressure vessel simulation component is placed above the top support plate.

Further, the indenter is connected to the second sliding assembly via an instrument guide rail connector; the instrument guide rail connector comprises an instrument connecting plate, an instrument connecting slider, a guide rail connecting plate, and a guide rail connecting slider; the guide rail connecting plate has an instrument connecting slot in a side near the indenter that mates with the instrument connecting slider, and another guide rail connecting slot in a side near the curved guide rail that mates with the guide rail connecting slider; a width of the instrument connecting slider is smaller than a width of the guide rail connecting slider, and a width of the instrument connecting slot is smaller than a width of the guide rail connecting slot.

The instrument connecting slider is fixedly disposed at a center portion of a side of the instrument connecting plate away from the indenter and slidably disposed within the instrument connecting slot of the guide rail connecting plate; the instrument connecting slider and the guide rail connecting slider are connected using bolts; and the instrument connecting plate and the guide rail connecting plate are respectively connected to an end of the indenter and the second sliding assembly using bolts.

Furthermore, after the indenter is adjusted to a detection position thereof using the moving mechanism, fixing is done using a chain; the chain circumferentially surrounds the pressure vessel simulation component, and both ends of the chain are connected to fixed hooks on a front side and a rear side of the indenter via tensioners; one end of the tensioner is fitted onto the fixed hook, and another end of the tensioner is connected to one end of the chain.

Furthermore, the tensioner comprises a tensioner rotating collar and tensioner sleeves disposed at both ends of the tensioner rotating collar; a first threaded rod and a second threaded rod are respectively fitted into the two tensioner sleeves, and threads of the first threaded rod and the second threaded rod have opposite directions; tensioner connecting locking holes are respectively provided at ends of the first threaded rod and the second threaded rod away from the tensioner rotating collar, and one of the tensioner connecting locking holes is fitted onto the fixed hook, while another of the tensioner connecting locking holes is connected to one end of the chain.

The present invention also provides a method for non-destructive testing of mechanical properties and residual stress of pressure vessels, comprising:
(1) selecting test points on a pressure vessel simulator according to experimental requirements and grinding the test points;
(2) injecting water into the pressure vessel simulator until a preset service pressure is reached, and maintaining the preset service pressure for at least 20 minutes to ensure uniform pressure distribution within the pressure vessel simulator;
(3) adjusting the indenter above the test points on the pressure vessel simulator using a moving mechanism and securing the indenter firmly;
(4) performing non-destructive testing on the test points of the pressure vessel simulator using the indenter to obtain load-displacement curves; and
(5) processing obtained load-displacement curves to calculate the mechanical properties and/or residual stress of the pressure vessel simulator under the preset service pressure.

Furthermore, when testing the mechanical properties of the pressure vessel simulator, at least one of the test points is selected in a heat-affected zone of the weld seam to be tested, and another of the test points is selected at a location far from the weld seam; a distance between two adjacent test points is at least 5 times a diameter of a maximum indentation; and
when testing the residual stress of the pressure vessel simulator, test points are selected along a direction perpendicular to the weld seam; at least one of the test points is selected at weld portions, and one of the test points is selected on each side of the heat-affected zone of the weld seam; additionally, a stress-free reference point is selected at a location far from the weld portions; following conditions must be met between adjacent test points: (1) a distance between geometric centers of two adjacent indentations is greater than 3 times an average diagonal length of the two indentations; and (2) a distance from a center of one of the indentations to an edge of another of the indentations is greater than 2.5 times the average diagonal length of the two indentations.

The present invention has the following beneficial effects:

It provides a device and method for non-destructive testing of the mechanical properties and residual stress of pressure vessels; the pressure vessel simulator can be made of dissimilar materials, enabling simultaneous simulation of different pressure vessel equipment in engineering sites or different materials in different parts of the same pressure vessel equipment; furthermore, the pressure vessel simulator in the present invention has circumferential and longitudinal welds, simulating non-destructive testing of different weld areas of pressure vessels in engineering sites. Moreover, the pressure vessel simulator can be pressurized with water to simulate the service pressure of pressure vessels. The present invention can simulate the service environment of pressure vessels in the laboratory and perform non-destructive testing on their mechanical properties and residual stress, accurately assessing safety and reliability of pressure vessels and providing theoretical guidance for pressure vessel manufacturing in engineering sites.

### BRIEF DESCRIPTION OF DRAWINGS

FIG. 1 is a structural schematic diagram of a detection device of the present invention;

FIG. 2 is a structural schematic diagram of a pressure vessel simulation component;

FIG. 3 is a structural schematic diagram of a moving mechanism;

FIG. 4 is an exploded view of an instrument guide rail connector;

FIG. 5 is a cross-sectional view of an instrument guide rail connector;

FIG. 6 is a schematic diagram of a detection device fixed using a chain;

FIG. 7 is a diagram showing a connection relationship between the chain, the tensioner, and the fixing hook when the detection device is fixed using a chain; and

FIG. 8 is a schematic diagram of the tensioner.

Numerical figures in the drawings are: 1. pressure vessel simulation component; 101. cylinder; 102. end cap; 103. first longitudinal weld; 104. second longitudinal weld; 105. intermediate circumferential weld; 106. water inlet; 107. pressure gauge mounting port; 108. safety valve mounting port; 2. indenter; 3. moving mechanism; 301. horizontal guide rail; 302. arc-shaped guide rail; 303. first sliding assembly; 304. second sliding assembly; 4. fixed base plate; 5. support assembly; 501. base support plate; 502. support plate; 503. top support plate; 6. instrument guide rail connector; 601. instrument connecting plate; 602. instrument connecting slider; 603. guide rail connecting plate; 604. guide rail connecting slider; 605. instrument connecting long slot; 606. guide rail connecting long slot; 7. chain; 8. tensioner; 801. tensioner rotating collar; 802. tensioner sleeve; 803. first threaded rod; 804. second threaded rod; 805. tensioner connecting locking hole; and 9. fixing hook.

### DETAILED DESCRIPTION OF EMBODIMENTS

The specific embodiments of the present invention will be further described below with reference to the accompanying drawings and specific examples.

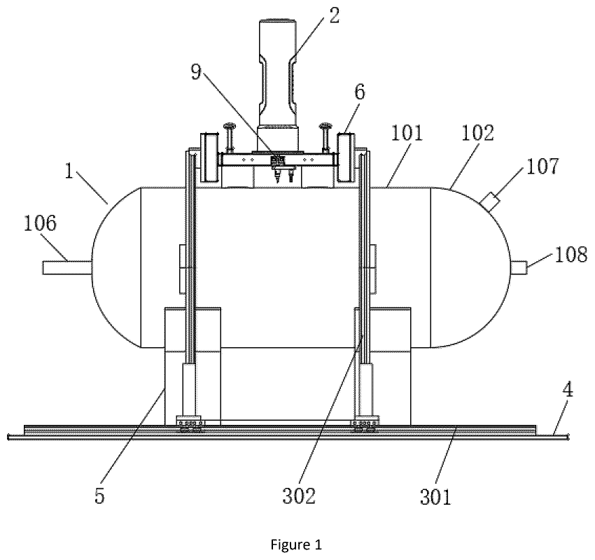

Referring to FIG. 1, the present embodiment provides a device for non-destructive testing of mechanical properties and residual stress of a pressure vessel, comprising a pressure vessel simulator 1, an indenter 2, and a moving mechanism 3. The pressure vessel simulator 1 simulates an industrial pressure vessel and provides a service environment similar to that of an industrial pressure vessel. The indenter 2 performs non-destructive testing on the pressure vessel simulator 1, and the moving mechanism 3 adjusts the testing position of the indenter 2.

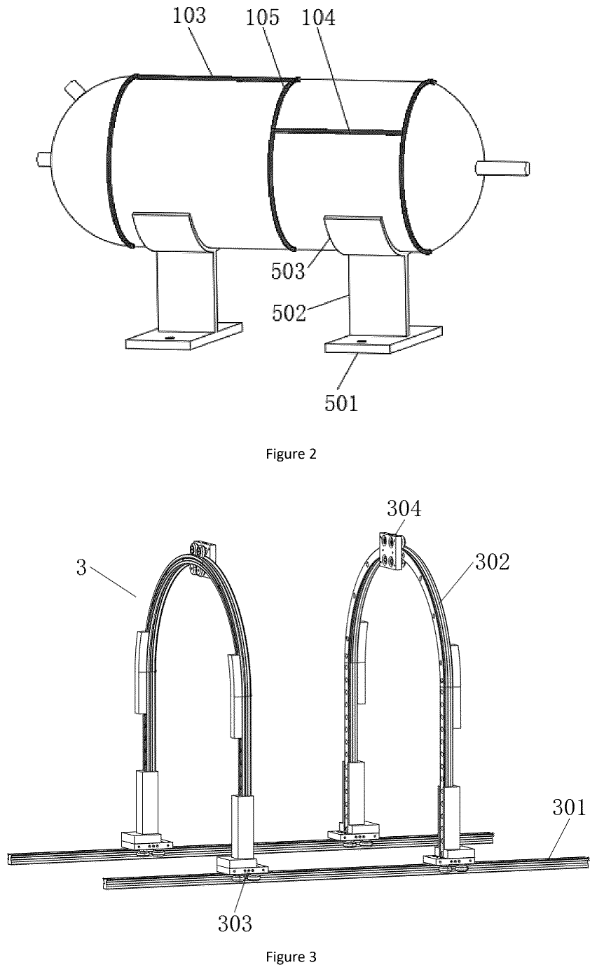

Referring to FIG. 2, the pressure vessel simulator 1 includes a cylinder 101 formed by welding a first cylinder section and a second cylinder section together, and end caps 102 disposed at both ends of the cylinder. Specifically, the first cylinder section and the second cylinder section are made of Q345R material and S30408 material, respectively. The first cylinder section and the second cylinder section are rolled and then welded to form a first longitudinal weld seam 103 and a second longitudinal weld 104, respectively, and a middle circumferential weld 105 is formed by welding the first cylinder section and the second cylinder section together. The first cylinder section and the second cylinder section are made of magnetic and non-magnetic materials, respectively, which can simultaneously simulate different pressure vessel equipment in an engineering site or different materials in different parts of the same pressure vessel equipment. Furthermore, the end caps 102 at both ends of the pressure vessel simulator 1 comprise spherical and elliptical end caps, respectively. By detecting the mechanical properties and stress distribution of different types of end caps, the influence of different types of end caps on the performance of the pressure vessel can be analyzed.

Additionally, one of the end caps 102 of the aforementioned pressure vessel simulator 1 is provided with a water inlet 106, and another of the end caps 102 is provided with a pressure gauge mounting port 107 and a safety valve mounting port 108. The water inlet 106 is used to inject water into the pressure vessel simulator 1 to render a certain pressure. The pressure gauge mounting port 107 is used to install a pressure gauge to monitor the internal pressure of the pressure vessel simulator. The safety valve mounting port 108 is used to install a safety valve to prevent the internal pressure of the pressure vessel simulator from exceeding a specified pressure value.

The device of the present invention embodiment also includes a fixed base plate 4. The pressure vessel simulator 1 is fixed to the fixed base plate 4 by a support assembly 5 located at a bottom portion of the cylinder and near the end caps at both ends. Specifically, the support assembly 5 includes a base support plate 501, a vertical support plate 502, and a top support plate 503. The base support plate 501 is fixed above the fixed base plate 4 using bolts. The two ends of the vertical support plate 502 are fixed to the base support plate 501 and the top support plate 503, respectively. The top support plate 503 is arc-shaped and matches the outer diameter of the pressure vessel simulation component 1. The pressure vessel simulation component 1 is placed on the top support plate 503, and when placing the pressure vessel simulation component 1, its first longitudinal weld 103 and second longitudinal weld 104 are located in the upper middle part of the pressure vessel simulation component 1.

Referring to FIG. 3, the moving mechanism 3 comprises two parallel horizontal guide rails 301 and two parallel arc-shaped guide rails 302. The arc-shaped guide rails 302 comprise an upper arc-shaped section and a lower vertical section. The two horizontal guide rails 301 are fixedly mounted above the fixed base plate 4, and the two arc-shaped guide rails 302 are vertically mounted above the horizontal guide rails 301. The bottom ends of each of the arc-shaped guide rails 302 are slidably connected to the two horizontal guide rails 301 via a first sliding assembly 303. A second sliding assembly 304 is provided on the opposite side of the two arc-shaped guide rails 302. The left and right ends of the indenter 2 are slidably connected to the two arc-shaped guide rails 302 via the second sliding assembly 304. The first sliding assembly 303 and the second sliding assembly 304 specifically comprise a pulley system consisting of at least two pulleys and a pulley mounting plate for mounting the pulleys. The first sliding assembly 303 and the second sliding assembly 304 allow the indenter 2 to move along the horizontal guide rail 301 or the arc-shaped guide rail 302, thereby adjusting the detection position of the indenter. Furthermore, the horizontal guide rail 301 or the arc-shaped guide rail 302 ensures that the test points are on the same straight line or the same circumference during movement of the indenter 2, and also allows the indenter 2 to move to positions of the two end caps for testing.

In addition, to facilitate fixing the indenter at its adjusted position, the present embodiment also provides locking bolts on one side of the pulley mounting plates of the first sliding assembly and the second sliding assembly. Specifically, for the first sliding assembly, the locking bolts are located above the pulley mounting plate, and the pulley mounting plate of the first sliding assembly has matching locking bolt holes. The locking bolts are screwed into these holes, with the ends abutting against the horizontal guide rail, thereby locking and fixing the first sliding assembly. For the second sliding assembly, the locking bolts are located on the outer side of the arc-shaped guide rail, and the arc-shaped guide rail has several bolt holes for the pulley mounting plates of the first sliding assembly. The locking bolts are screwed into these holes on the arc-shaped guide rail, with the ends abutting against the pulley mounting plate of the second sliding assembly, thereby locking and fixing the second sliding assembly.

In addition, to ensure that the indenter can detect the middle region and the upper region of the pressure vessel simulation component, the present embodiment features an arc-shaped guide rail surrounding the pressure vessel simulation component, with the bottom end of the upper arc-shaped section of the guide rail flush with the central axis of the pressure vessel simulation component.

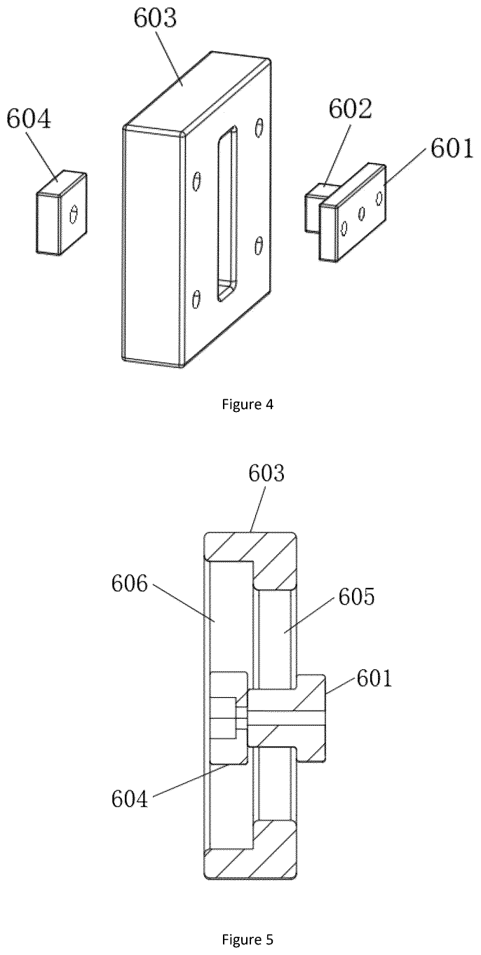

Referring to FIG. 4, the indenter 2 is connected to the second sliding assembly 304 via an instrument guide rail connector 6. The instrument guide rail connector 6 includes an instrument connecting plate 601, an instrument connecting slider 602, a guide rail connecting plate 603, and a guide rail connecting slider 604. The guide rail connecting plate 603 has an instrument connecting slot 605 on the side near the indenter 2, which mates with the instrument connecting slider 602. The guide rail connecting plate 603 also has a guide rail connecting slot 606 on the side near the arc-shaped guide rail, which mates with the guide rail connecting slider 604. Furthermore, the width of the instrument connecting slider 602 is smaller than the width of the guide rail connecting slider 604, and the width of the instrument connecting slot 605 is smaller than the width of the guide rail connecting slot 606.

The instrument connecting slider 602 is smaller than the width of the guide rail connecting slider 604, and the width of the instrument connecting slot 605 is smaller than the width of the guide rail connecting slot 606. The aforementioned instrument connecting slider 602 is fixedly mounted on the center of the instrument connecting plate 601 on the side away from the indenter 2 and slidably mounted within the instrument connecting slot 605 of the guide rail connecting plate 603. The guide rail connecting slider 604 is slidably mounted within the guide rail connecting slot 606 of the guide rail connecting plate 603. The instrument connecting slider 602 and the guide rail connecting slider 604 are connected by bolts. The instrument connecting plate 601 and the guide rail connecting plate 603 are respectively connected to the end of the indenter 2 and the pulley mounting plate of the second sliding assembly 304 using bolts.

The indenter 2 is connected to the second sliding assembly 304 via the aforementioned instrument guide rail connector 6. When the position of the indenter needs to be adjusted, the indenter 2 can be moved along the instrument connecting slot 605 and the guide rail connecting slot 606 on the guide rail connecting plate 603, allowing the indenter 2 to detach from the surface of the pressure vessel simulation component, preventing impact to the indenter and preventing scratches on the surface of the pressure vessel simulation component.

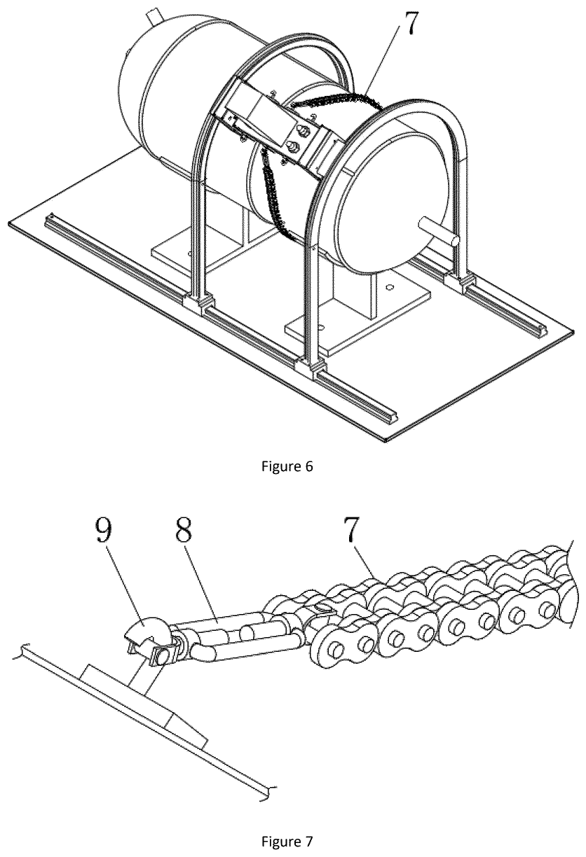

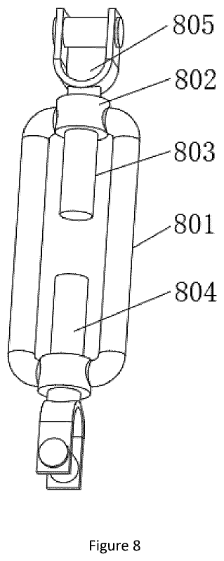

Referring to FIG. 5, to further ensure the indenter is securely fixed, the indenter 2 is adjusted in its detection position via the moving mechanism 3 and then fixed by a chain 7. The chain 7 surrounds the pressure vessel simulator 1 circumferentially, and both ends of the chain 7 are connected to the front fixing hook and the rear fixing hook 9 of the indenter 2 via tensioners 8. One end of the tensioner 8 is fitted onto the fixing hook 9, and another end of the tensioner 8 is connected to one end of the chain 7.

Specifically, the aforementioned tensioner 8 comprises a tensioner rotating collar 801 and tensioner sleeves 802 fixedly disposed at both ends of the tensioner rotating collar 801. The tensioner sleeves 802 are provided with internal threads. A first threaded rod 803 and a second threaded rod 804 are respectively fitted inside the two tensioner sleeves 802, and the threads of the first threaded rod 803 and the second threaded rod 804 have opposite directions. Furthermore, each of the first threaded rod 803 and the second threaded rod 804 has a tensioner connecting locking hole 805 at the end away from the tensioner rotating collar 801. One tensioner connecting locking hole 805 is fitted onto the fixing hook 9, and the other tensioner connecting locking hole 805 is connected to one end of the chain 7.

After the indenter's detection position is adjusted, it can be fixed with locking bolts; or first, it can be fixed with locking bolts, then the chain can be used to wrap around the pressure vessel simulator circumferentially, and the chain length can be adjusted using a tensioner to make the chain taut and fix the indenter firmly; or, it can be fixed without locking bolts, first hold the indenter by hand, and then fix it directly with the chain.

Based on the above non-destructive testing device, the mechanical properties and residual stress of the pressure vessel are non-destructively tested, comprising:
(1) select test points on the pressure vessel simulator according to the test requirements, and grind the test points. Specifically, use a grinding wheel to remove excess material from the weld, and use an impeller to remove the oxide layer on the surface of the base material. Then, use sandpaper to grind from 100 grit to 400 grit, and try to avoid surface slope during the grinding process;
(2) Inject water into the pressure vessel simulator, observe and record the pressure gauge readings until the preset service pressure is reached, and the pressure reaches . . . (2) After setting the service pressure, maintain stability for at least 20 minutes to ensure uniform pressure distribution within the pressure vessel simulator;
(3) Adjust the position of the indenter using the moving mechanism to ensure the indenter head is above the test point on the pressure vessel simulator, and secure the indenter firmly using locking bolts and/or chains;
(4) Perform non-destructive testing on the test point of the pressure vessel simulator using the indenter to obtain the load-displacement curve;
(5) Process the obtained load-displacement curves to calculate the mechanical properties and/or residual stress of the pressure vessel simulator under service pressure.

When testing the mechanical properties of a pressure vessel simulator using the above-mentioned non-destructive testing device, a spherical indenter is used for the indenter, and at least one test point is selected in the heat-affected zone of the weld to be tested, and another test point is selected at a location far from the weld. The following conditions must be met between adjacent test points: the distance between two adjacent test points (i.e., the distance between the geometric centers of two adjacent indentations) is at least 5 times the maximum indentation diameter.

When testing the residual stress of a pressure vessel simulator using the above-mentioned non-destructive testing device, a Knoop indenter is used for the indenter, and test points must be selected along the direction perpendicular to the weld. At least one test point is selected at the weld location, and one test point is selected on each side of the heat-affected zone of the weld. A stress-free reference point is also selected at a location far from the weld. The following conditions must be met between adjacent test points: the distance between the geometric centers of two adjacent indentations is greater than 3 times the average diagonal length of the two indentations; (2) the distance from the center of one indentation to the edge of the other indentation is greater than 2.5 times the average diagonal length of the two indentations.

In addition, during the above testing process, after testing one test point, the locking bolts and/or chain need to be loosened first, and the indenter moved along the instrument connection slot and guide rail connection slot on the guide rail connecting plate to detach the indenter from the surface of the pressure vessel simulation part. Then, the indenter is adjusted to the next test point, and after adjustment, it is fixed securely again.

The present embodiment utilizes the above-mentioned non-destructive testing device to detect the mechanical properties and residual stress of the pressure vessel simulation part under similar industrial service environments, providing theoretical guidance for the design and manufacture of industrial pressure vessels.

It should be noted that parts not mentioned in the present invention can be implemented by adopting or referencing existing technologies.

Of course, the above description is not a limitation of the present invention, and the present invention is not limited to the examples given above. Changes, modifications, additions, or substitutions made by those skilled in the art within the scope of the present invention should also fall within the protection scope of the present invention.

1. A device for non-destructive testing of mechanical properties and residual stress of pressure vessels, comprising a pressure vessel simulator, an indenter, and a moving mechanism;
the pressure vessel simulator comprises a cylinder formed by butt welding a first cylinder section and a second cylinder section, and end caps disposed at both ends of the cylinder;
both the first cylinder section and the second cylinder section are formed by rolling and welding; one of the end caps of the pressure vessel simulator is provided with a water inlet, and another of the end caps is provided with a pressure gauge mounting port and a safety valve mounting port;
the moving mechanism comprises two parallel horizontal guide rails and two parallel arc-shaped guide rails; the curved guide rails are vertically positioned above the horizontal guide rails; bottom ends of each of the curved guide rails are slidably connected to the two horizontal guide rails via a first sliding assembly; a second sliding assembly is located on opposite sides of the two curved guide rails; and a left end and a right end of the indenter are slidably connected to the two curved guide rails via the second sliding assembly; and
the pressure vessel simulation component is fixed to a fixed base plate using a support assembly located at a bottom portion of the cylinder near the end caps; the two curved guide rails surround the pressure vessel simulation component; the indenter adjusts a detection position thereof via the moving mechanism and performs non-destructive testing on the pressure vessel simulation component.

2. The device for non-destructive testing of mechanical properties and residual stress of pressure vessels according to claim 1, wherein the first cylinder section and the second cylinder section of the pressure vessel simulation component are made of the same material or different materials;
the pressure vessel simulation component has an intermediate circumferential weld seam formed by butt welding of the first cylinder section and the second cylinder section, and a first longitudinal weld seam and a second longitudinal weld seam formed by welding the first cylinder section and the second cylinder section after rolling to be the cylinder.

3. The device for non-destructive testing of mechanical properties and residual stress of pressure vessels according to claim 1, wherein the two horizontal guide rails are fixedly positioned above the fixed base plate.

4. The device for non-destructive testing of mechanical properties and residual stress of pressure vessels according to claim 1, wherein the first sliding assembly comprises a slider or a pulley system, and the second sliding assembly comprises a pulley system.

5. The device for non-destructive testing of mechanical properties and residual stress of pressure vessels according to claim 1, wherein the support assembly comprises a base support plate, a vertical support plate, and a top support plate; the base support plate is fixedly disposed above the fixed base plate; both ends of the vertical support plate are respectively fixed to the base support plate and the top support plate; the top support plate is arc-shaped and matches an outer diameter of the pressure vessel simulation component and the pressure vessel simulation component is placed above the top support plate.

6. The device for non-destructive testing of mechanical properties and residual stress of pressure vessels according to claim 1, wherein the indenter is connected to the second sliding assembly via an instrument guide rail connector; the instrument guide rail connector comprises an instrument connecting plate, an instrument connecting slider, a guide rail connecting plate, and a guide rail connecting slider; the guide rail connecting plate has an instrument connecting slot in a side near the indenter that mates with the instrument connecting slider, and another guide rail connecting slot in a side near the curved guide rail that mates with the guide rail connecting slider; a width of the instrument connecting slider is smaller than a width of the guide rail connecting slider, and a width of the instrument connecting slot is smaller than a width of the guide rail connecting slot;
the instrument connecting slider is fixedly disposed at a center portion of a side of the instrument connecting plate away from the indenter and slidably disposed within the instrument connecting slot of the guide rail connecting plate; the instrument connecting slider and the guide rail connecting slider are connected using bolts; and the instrument connecting plate and the guide rail connecting plate are respectively connected to an end of the indenter and the second sliding assembly using bolts.

7. The device for non-destructive testing of mechanical properties and residual stress of pressure vessels according to claim 1, wherein after the indenter is adjusted to a detection position thereof using the moving mechanism, fixing is done using a chain; the chain circumferentially surrounds the pressure vessel simulation component, and both ends of the chain are connected to fixed hooks on a front side and a rear side of the indenter via at least one tensioner; one end of the at least one tensioner is fitted onto the fixed hook, and another end of the at least one tensioner is connected to one end of the chain.

8. The device for non-destructive testing of mechanical properties and residual stress of pressure vessels according to claim 7, wherein the tensioner comprises a tensioner rotating collar and tensioner sleeves disposed at both ends of the tensioner rotating collar; a first threaded rod and a second threaded rod are respectively fitted into the two tensioner sleeves, and threads of the first threaded rod and the second threaded rod have opposite directions; tensioner connecting locking holes are respectively provided at ends of the first threaded rod and the second threaded rod away from the tensioner rotating collar, and one of the tensioner connecting locking holes is fitted onto the fixed hook, while another of the tensioner connecting locking holes is connected to one end of the chain.

9. A method for non-destructive testing of mechanical properties and residual stress of pressure vessels by using the device defined in claim 1, comprising:
(1) selecting test points on a pressure vessel simulator according to experimental requirements and grinding the test points;
(2) injecting water into the pressure vessel simulator until a preset service pressure is reached, and maintaining the preset service pressure for at least 20 minutes to ensure uniform pressure distribution within the pressure vessel simulator;
(3) adjusting the indenter above the test points on the pressure vessel simulator using the moving mechanism and securing the indenter firmly;
(4) performing non-destructive testing on the test points of the pressure vessel simulator using the indenter to obtain load-displacement curves; and
(5) processing obtained load-displacement curves to calculate the mechanical properties and/or residual stress of the pressure vessel simulator under the preset service pressure.

10. The method for non-destructive testing of mechanical properties and residual stress of pressure vessels according to claim 9, wherein when testing the mechanical properties of the pressure vessel simulator, at least one of the test points is selected in at least one heat-affected zone of weld seams to be tested, and another of the test points is selected at a location far from the weld seam; a distance between two adjacent test points is at least 5 times a diameter of a maximum indentation; and
when testing the residual stress of the pressure vessel simulator, test points are selected along a direction perpendicular to the weld seams; at least one of the test points is selected at welding portions, and one of the test points is selected on each side of the at least one heat-affected zone of the weld seams; additionally, a stress-free reference point is selected at a location far from the weld portions; following conditions must be met between adjacent test points: (1) a distance between geometric centers of two adjacent indentations is greater than 3 times an average diagonal length of the two indentations; and (2) a distance from a center of one of the indentations to an edge of another of the indentations is greater than 2.5 times the average diagonal length of the two indentations.
